(19) United States
(12) Patent Application Publication
(10) Pub. No.: US 2026/0038889 A1
(43) Pub. Date: Feb. 5, 2026

(54) SELF-REGULATING BATTERY CELL

(71) Applicant: Caterpillar Inc., Peoria, IL (US)

(72) Inventor: Wellington Ying-wei Kwok, Dunlap, IL (US)

(73) Assignee: Caterpillar Inc., Peoria, IL (US)

(21) Appl. No.: 18/793,045

(22) Filed: Aug. 2, 2024

(51) Int. Cl. H01M 10/42; B60L 58/12; B60L 58/26; H01M 10/48; H01M 10/613; H01M 10/625; H01M 10/6553; H01M 10/6572; H01M 50/209; H01M 50/51; H02J 7/00

(52) U.S. Cl. CPC H01M 10/425; B60L 58/12; B60L 58/26; H01M 10/482; H01M 10/613; H01M 10/625; H01M 10/6553; H01M 10/6572; H01M 50/209; H01M 50/51; H02J 7/0019; B60L 2200/40; H01M 2220/20

(57) ABSTRACT

A battery cell system includes multiple battery cells and a control circuit. The battery cells include an internal cell resistance. The control circuit is configured to detect when a charge level of a first battery cell of the battery system is greater than a charge level of a second battery cell of the battery system; and activate an internal cell resistance of the first battery cell to reduce the charge level of the first battery cell and deactivate the internal cell resistance when the charge level of the first battery cell is within a specified threshold charge level of the second battery cell.

### TECHNICAL FIELD

This document relates to rechargeable battery cell technology and in particular to techniques of balancing the state of charge of the battery cells when the battery cells are connected together in multi-cell battery modules to power large work machines.

### BACKGROUND

Powering a large moving work machine (e.g., a wheel loader) with an electric motor requires a large mobile electric energy source that can provide current of tens to hundreds of Amperes (Amps). Multiple large capacity battery cells can be connected in series as battery cell strings, and the battery cell strings can be connected in parallel in battery packs to provide the sustained energy power needed by a large electric-powered moving work machine. However, when multiple battery cell strings are connected together it is desirable to charge the battery cells in a manner that avoids large differences in the state of charge of the battery cells that could cause large inrush currents that could potentially damage the battery cells. U.S. Pat. No. 11,367,910 relates to an integrated heating and battery system.

### SUMMARY OF THE INVENTION

Electric powered work machines use large capacity battery cell systems to power the work machines. The battery cells of a large capacity battery cell system should be balanced in their state of charge when brought online.

An example battery cell system includes multiple battery cells and a control circuit. The battery cells include an internal cell resistance. The control circuit is configured to detect when a charge level of a first battery cell of the battery system is greater than a charge level of a second battery cell of the battery system; and activate an internal cell resistance of the first battery cell to reduce the charge level of the first battery cell and deactivate the internal cell resistance when the charge level of the first battery cell is within a specified threshold charge level of the second battery cell.

### BRIEF DESCRIPTION OF THE DRAWINGS

FIG. 1 is an elevation view depicting an example work machine in accordance with this disclosure.

FIG. 2 is a block diagram of an example of a battery cell system in accordance with this disclosure.

FIG. 3 is an illustration of an example of a battery cell in accordance with this disclosure.

FIG. 4 is a circuit diagram of an example of a battery cell in accordance with this disclosure.

FIG. 5 is a circuit diagram of an example of a battery string with multiple battery cells in accordance with this disclosure.

FIG. 6 is an illustration of an example of multiple battery cells and a heat transfer mechanism in accordance with this disclosure.

FIG. 7 is an illustration of a side view of an example of a battery cell in accordance with this disclosure.

FIG. 8 is an illustration of an example of a battery cell and another example of a heat transfer mechanism in accordance with this disclosure.

FIG. 9 is a circuit diagram of the battery cell in the example of FIG. 8 in accordance with this disclosure.

FIG. 10 is a flow diagram of an example of a method of operating a battery cell system in accordance with this disclosure.

### DETAILED DESCRIPTION

Examples according to this disclosure are directed to methods and systems for automatically balancing the battery cells of a large capacity battery cell system.

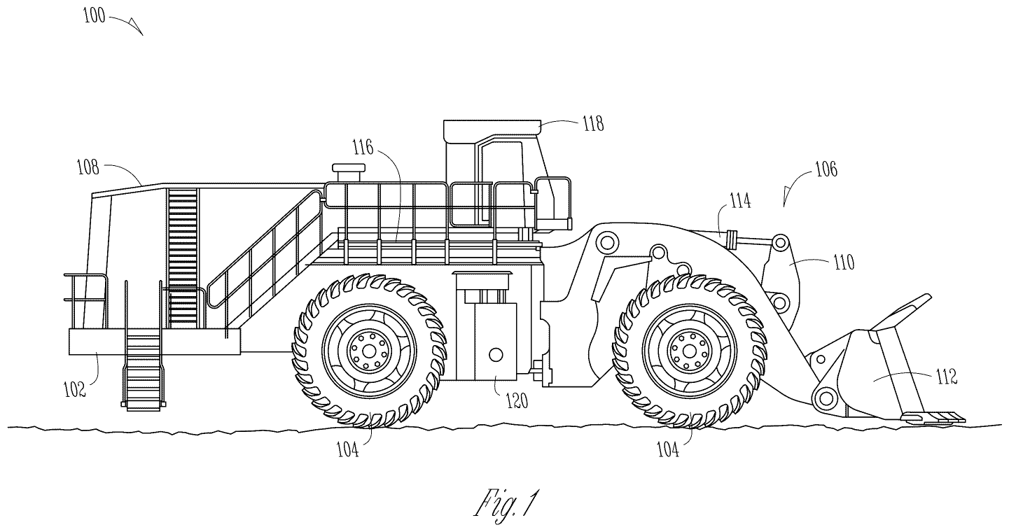

FIG. 1 depicts an example machine 100 in accordance with this disclosure. In FIG. 1, machine 100 includes frame 102, wheels 104, implement 106, and a speed control system implemented in one or more on-board electronic devices like, for example, an electronic control unit or ECU. Example machine 100 is a wheel loader. In other examples, however, the machine may be other types of machines related to various industries, including, as examples, construction, agriculture, forestry, transportation, material handling, waste management, and so on. Accordingly, although a number of examples are described with reference to a wheel loader machine, examples according to this disclosure are also applicable to other types of machines including graders, scrapers, dozers, excavators, compactors, material haulers like dump trucks, along with other example machine types.

Machine 100 includes frame 102 mounted on four wheels 104, although, in other examples, the machine could have more than four wheels. Frame 102 is configured to support and/or mount one or more components of machine 100. For example, machine 100 includes enclosure 108 coupled to frame 102. Enclosure 108 can house, among other components, an electric motor to propel the machine over various terrain via wheels 104. In some examples, multiple electric motors are included in multiple enclosures at multiple locations of the machine 100.

Machine 100 includes implement 106 coupled to the frame 102 through linkage assembly 110, which is configured to be actuated to articulate bucket 112 of implement 106. Bucket 112 of implement 106 may be configured to transfer material such as, soil or debris, from one location to another. Linkage assembly 110 can include one or more cylinders 114 configured to be actuated hydraulically or pneumatically, for example, to articulate bucket 112. For example, linkage assembly 110 can be actuated by cylinders 114 to raise and lower and/or rotate bucket 112 relative to frame 102 of machine 100.

Platform 116 is coupled to frame 102 and provides access to various locations on machine 100 for operational and/or maintenance purposes. Machine 100 also includes an operator cabin 118, which can be open or enclosed and may be accessed via platform 116. Operator cabin 118 may include one or more control devices (not shown) such as, a joystick, a steering wheel, pedals, levers, buttons, switches, among other examples. The control devices are configured to enable the operator to control machine 100 and/or the implement 106. Operator cabin 118 may also include an operator interface such as, a display device, a sound source, a light source, or a combination thereof.

Machine 100 can be used in a variety of industrial, construction, commercial or other applications. Machine 100 can be operated by an operator in operator cabin 118. The operator can, for example, drive machine 100 to and from various locations on a work site and can also pick up and deposit loads of material using bucket 112 of implement 106. As an example, machine 100 can be used to excavate a portion of a work site by actuating cylinders 114 to articulate bucket 112 via linkage assembly 110 to dig into and remove dirt, rock, sand, etc. from a portion of the work site and deposit this load in another location.

Machine 100 can include a battery compartment connected to frame 102 and including a battery cell system 120. Battery cell system 120 is electrically coupled to the one or more electric motors of the machine 100.

In a typical large capacity battery cell system 120, individual battery cells are connected in a series-parallel configuration to form a high-voltage and high-energy multi-cell array. With manufacturing variance and environmental conditions, each battery cell within the multi-cell array could behave differently during charge-discharge cycling operations (due to the differences in cell capacity, impedance, temperature, etc.). This can result in state of charge (SoC) deviation between cells over time. The SoC of the cells of the system should be rebalanced from time to time to maintain proper operation.

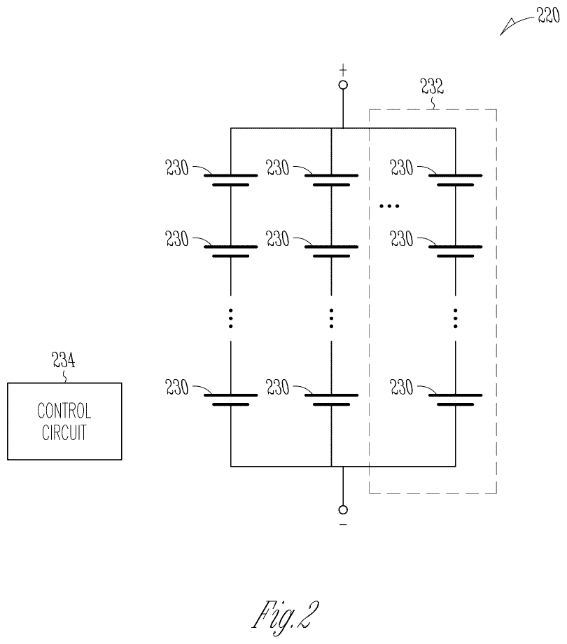

FIG. 2 is a block diagram of an example of a battery cell system 220. The battery cell system 220 be used to provide power to a work machine, such as the example machine 100 of FIG. 1. The battery cell system 220 includes multiple battery cells 230. The battery cells may be Lithium-Ion battery (LIB) cells, Sodium-Ion battery (SIB) cells, Lead-Acid (PbA) battery cells, Nickel-Zinc (Ni—Zn) battery cells, Metal-Air battery cells, Solid-State battery (SSB) cells, etc. The battery cells are connected in series to form battery cell strings 232. In an example, the battery cell strings 232 can include two to twelve 58 Volt, 80 Amp-hour batteries or 60 kilowatt-hour batteries. The battery cell system 220 includes multiple battery cell strings 232 (e.g., two to eight battery cell strings) connected in parallel.

The battery cells 230 are rechargeable. The battery cell system 120 includes a control circuit 234 to bring the battery cell strings 232 online in a discharge state to provide electrical energy to a work machine and a charge state to recharge the battery cells 230. The control circuit 234 may include processing circuitry that includes logic to perform the functions described. The processing circuitry may include a microprocessor, application specific integrated circuit (ASIC), programmable gate array (PGA), or other type of processor, interpreting or executing instructions in software or firmware. In some examples, the control circuit 234 includes a logic sequencer circuit. A logic sequencer refers to a state machine or other circuit that sequentially steps through a fixed series of steps to perform the functions described. A logic sequencer circuit can be implemented using hardware, firmware, or software.

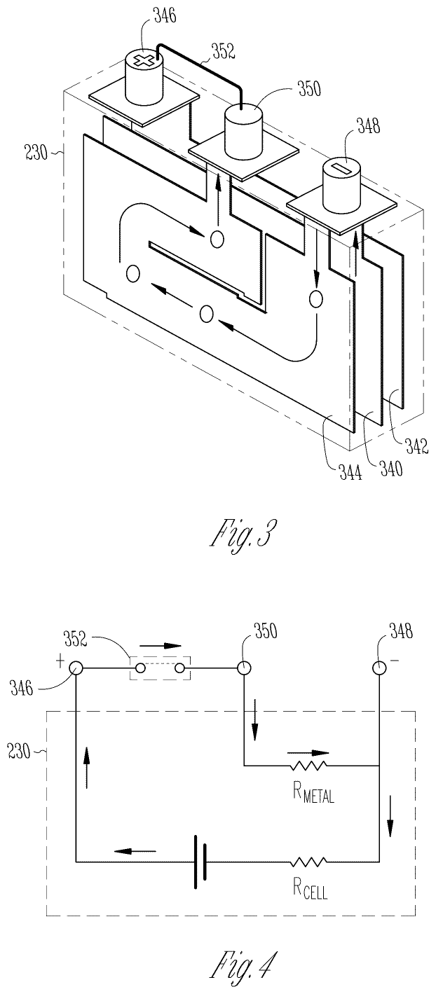

FIG. 3 is an illustration of an example of a battery cell 230. The battery cell 230 shows an anode plate 340 and a cathode plate 342. The battery cell 230 includes multiple anode plates and cathode plates in a plate stack. The example battery cell 230 in FIG. 3 shows only one anode plate 340 and one cathode plate 342 for simplicity of the illustration. The battery cell 230 also shows a metal foil 344. In an example intended to be non-limiting, the metal foil can include nickel. The example battery cell in FIG. 3 shows only one metal foil 344 but the battery cell 230 includes multiple metal foils 344 interleaved with the plates of the cell plate stack of the battery cell 230. In certain examples, the metal foils 344 are added in place of some of the anode plates 340. The interleaved metal foils are connected together.

The battery cell 230 includes three battery terminals: a positive terminal 346, a negative terminal 348, and a third terminal 350. The third terminal 350 is electrically connected to the metal foils 344. The metal foils 344 can form an internal resistance for the battery cell 230 and the third terminal 350 can be a resistance terminal for the battery cell 230. The battery cell 230 includes a switch circuit 352 that can connect the third terminal 348 to the positive terminal 346. In variations, the switch circuit 352 can connect the third terminal 350 to the negative terminal 348. In some examples, the switch circuit 352 includes a field effect transistor (FET) and the control circuit 234 can activate the FET to connect the third terminal 350 to the positive terminal 346.

FIG. 4 is a circuit diagram of the battery cell 230. The internal cell resistance from the metal foils R_{METAL} is connected to the negative terminal 348 and is electrically unconnected from the positive terminal 346. Activating or closing the switch circuit 352 connects the positive terminal 346 to the metal foils forming what is essentially an internal cell circuit loop including the battery potential difference, the switch circuit 352, the internal cell resistance from the metal foils R_{METAL}, and the resistance of the battery cell R_{CELL} due to the plate stack.

To monitor the state of charge (SoC) of the battery cells 230 during a charging cycle, the battery cell system 220 in FIG. 2 includes voltage sensors that are readable by the control circuit 234. The battery cell system 220 may include a voltage sensor for each battery cell 230, or the battery cell system 220 can include less voltage sensor circuits than battery cells 230 and one voltage sensor can be used to monitor the SoC of more than one battery cell 230. At the end of a charging cycle the battery cells may have different states of charge. If the difference between the charge is too great, the control circuit 234 activates the switch circuit 352 of one or more of the battery cells 230. Activating the switch circuit results in the charge of a battery cell 230 being passively reduced using the resistance of the internal metal foils of the battery cell 230 as a balancing resistor.

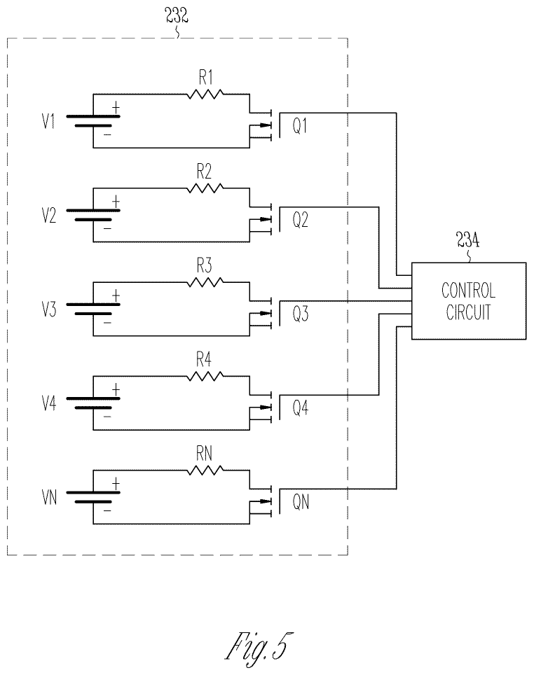

FIG. 5 is a circuit diagram of an example of a battery string 232 of n battery cells (V1, V2, V3, V4, . . . . VN), where N is an integer of five or greater. The FETS Q1, Q2, . . . . Qn are included in the switch circuits of the battery cells. In the example of FIG. 5, the switch circuits connect the internal cell resistances (R1, R2, R3, R4, . . . . Rn) of the battery cells to the negative terminal of the battery cells. The control circuit 234 determines the difference in SoC of the battery cells 230. If the difference between the charge of battery cells is too great (e.g., greater than a specified threshold difference in charge), the control circuit 234 activates the switch circuits to connect the internal cell resistances as balancing resistors and reduce the difference in the level of charge between the battery cells. The control circuit 234 may disconnect the battery cells 230 from other battery cells of the battery cell string 232 before activating the switch circuits 352 and the internal cell resistances. Once the charge of the battery cells is balanced to the point that the battery cells 230 are at the same SoC or within a specified (e.g., programmed) threshold level of charge, the control circuit 234 deactivates the switch circuits and may reconnect the battery cells 230 to the battery cell string 232.

Using the internal cell resistances has advantages over using external resistances. As battery cell capacity increases, it becomes difficult to dissipate heat away from the balancing external resistors. Low wattage external resistors can be used to limit the balancing current (e.g., to 100-150 milliamps) but the time to complete the cell balancing may be hours or days depending on the extent of the deviation in charge between battery cells 230. Using the internal metal foils of the battery cells 230 as charge balancing resistances one percent of the SoC of the battery cell 230 can be discharge in minutes. The heat from the discharge current can be controlled by modulating the activation of switch circuits Q1, Q2, . . . . Qn or allowing cooling periods or rest periods between discharge pulses. Even with rest periods, the time to balance charge among the battery cells 230 is significantly reduced over the external resistor approach.

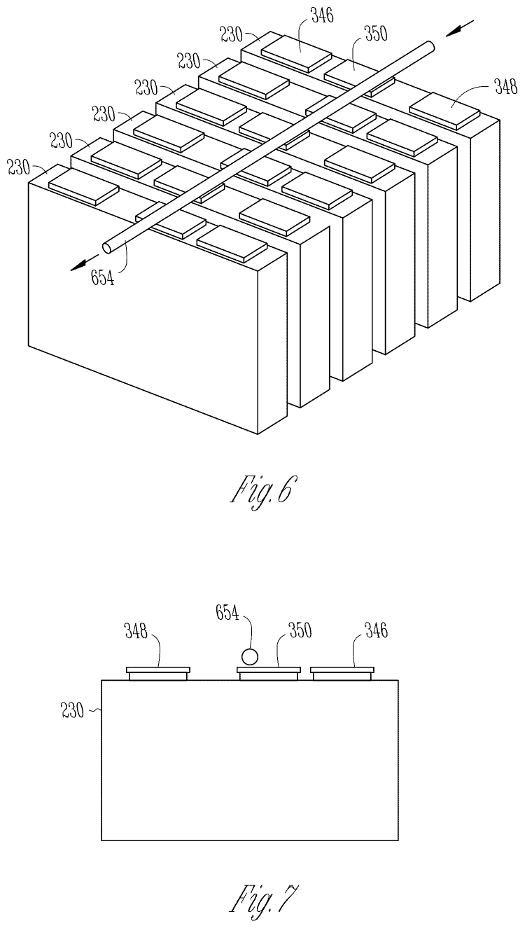

FIG. 6 is an illustration of an example of multiple battery cells 230 that can be included in a battery module of a battery cell system. The battery cells include a positive terminal 346, a negative terminal 348, and a third terminal 350 that is connected to metal foils internal to the battery cells 230. FIG. 7 is an illustration of an end view of the battery cells 230 in FIG. 6. Operating rechargeable battery cells (e.g., Lithium-Ion Batteries) at elevated temperatures may accelerate degradation of the batteries leading to shorter battery life. It is desirable to remove heat that develop in a battery module in which the battery cells are packed close together, such as during a fast-charging cycle for example. A heat transfer mechanism can be used to dissipate heat away from the metal foils of the battery cells 230 to cool the battery cell 230.

In FIGS. 6 and 7 the heat transfer mechanism is a cooling busbar 654 contacting the third terminals 350 of the battery cells 230. The cooling busbar 654 may include a lumen to carry liquid through the cooling busbar 654. The cooling busbar 654 removes heat from the third terminal 350 and the metal foils internal to the battery cell 230 to cool the battery cell 230.

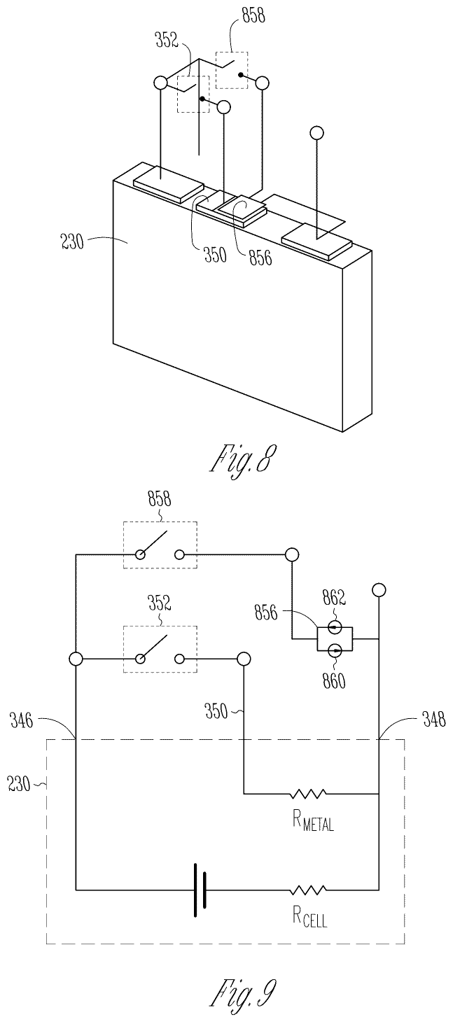

FIG. 8 is an illustration of an example of a battery cell 230 and another example of a heat transfer mechanism. The battery cell 230 includes a third terminal 350 connected to the metal foils internal to the battery cell 230, or otherwise in thermal communication with the metal foils. The battery cell includes a Peltier element 856 attached to the third terminal 350. The Peltier element 856 may be a Peltier junction semiconductor device incorporated into the third terminal 350. Heat removal from the battery cell 230 is achieved by conduction using the interleaved metal foils internal to the battery cell 230.

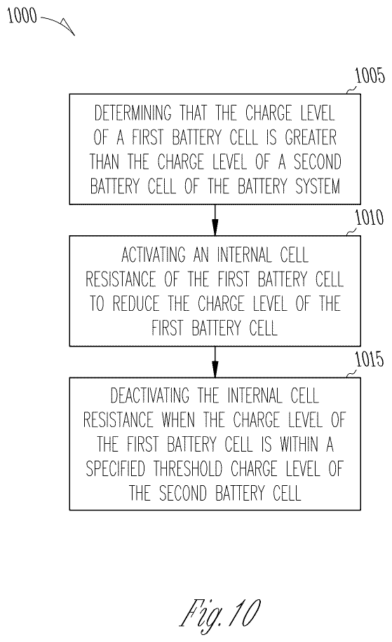

FIG. 9 is a circuit diagram of the battery cell example in FIG. 8. Heat removal is controlled by flowing current in the “refrigeration mode” 860 in the Peltier element 860. Current flows in the other direction 862 in the Peltier element 856 in the “power generation mode.” An additional switch circuit 858 may be included to activate or modulate the cooling process. Depending on the heat load, the Peltier element may be cooled by natural convection, forced convection using air flow, or active cooling with a liquid cold plate or cooling bus bar, or other heat transfer method.

The control circuit 234 of the battery cell system 220 determines a temperature of the battery cells 230 of a battery module. The battery cell system 200 may include a temperature sensor for the battery module or each of the battery cells. The control circuit 234 may activate the switch circuit 858 to connect the interleaved metal foils to the Peltier element 856 or other heat transfer device when the temperature of the battery cells 230 becomes greater than a specified threshold temperature during a charging cycle of the battery cell system 220. Use of the interleaved metal foils internal to the battery cell 230 with a cooling device can provide enhanced thermal management of a battery cell system.

### INDUSTRIAL APPLICABILITY

FIG. 10 is a flow diagram of an example of a method 1000 of operating a battery cell system 220 that includes multiple connected battery cells. The method 1000 may be performed using the battery cell system 220 of FIG. 2. The battery cells may be connected in series, parallel, or a combination of series and parallel. The control circuit of the battery cell system may receive a command to balance the charge level of the battery cells, or the control circuit may progress to the balancing operation after a charging operation or a command to ready the battery cell system for discharging.

At block 1005, the control circuit determines that at least two battery cells are unbalanced in that the charge level of one of the battery cells is greater than the charge level of another battery cell by more than a threshold charge level difference. More than two of the battery cells may be unbalanced. The control circuit determines battery cell with the lowest SoC. The battery cells may include voltage sensors, and the control circuit determines the battery cell with the lowest voltage as the battery cell with the lowest SoC. The control circuit initiates passive dissipation of the charge in the other battery cell or cells to bring the level of charge of the other battery cells to the charge level of the lowest battery cell.

At block 1010, the control circuit activates the internal cell resistance of the higher charged battery cell or cells. The internal cell resistance of a battery cell can be the resistance of multiple metal foils in the battery cell that are interleaved with the cell plate stack of the battery cell. The internal cell resistances may be activated by disconnecting the positive terminal from the other battery cells and closing a switch to connect the positive terminal to the resistive terminal of the battery cell that is connected to the interleaved metal foils. In variations, the negative terminal of the battery cell is disconnected from the other battery cells and the negative terminal is connected to the resistive terminal of the battery cell. An internal cell circuit loop is completed by changing the battery cell terminal connections (as shown in FIG. 4), and the charge dissipates through the resistance of the internal cell circuit loop.

At block 1015, the control circuit detects when the charge levels of the dissipating battery cells are balanced with the lowest charge battery cell. The control circuit may detect balancing by detecting when the charge levels of the dissipating battery cells are within a specified threshold charge level of the lowest charge battery cell. In certain examples, the control circuit may detect balancing by detecting when the voltages of the dissipating battery cells are within a specified threshold voltage of the lowest voltage battery cell. The control circuit deactivates the internal cell resistance of the battery cells when the cells are balanced. The internal cell resistance may be deactivated by opening the switch connected to the resistive terminal of the battery cell.

Internal metal foils of a battery cell interleaved internally with the plates of the plate stack of the battery cell form a fast-acting balancing resistance for the battery cells of a multi-cell battery module or battery pack. The metal foils can also be in thermal communication with a heat transfer device external to the battery cell to provide thermal management for the battery cells.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B″) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

The above detailed description is intended to be illustrative, and not restrictive. The scope of the disclosure should, therefore, be determined with references to the appended claims, along with the full scope of equivalents to which such claims are entitled.

What is claimed is:

1. A battery cell system for a work machine, the system comprising:
multiple battery cells, wherein the battery cells include an internal cell resistance; and
a control circuit configured to:
detect when a charge level of a first battery cell of the battery system is greater than a charge level of a second battery cell of the battery system; and
activate an internal cell resistance of the first battery cell to reduce the charge level of the first battery cell and deactivate the internal cell resistance when the charge level of the first battery cell is within a specified threshold charge level of the second battery cell.

2. The system of claim 1, wherein the internal cell resistance includes multiple connected metal resistance foils interleaved with battery cell plates of the first battery cell.

3. The system of claim 1,
wherein the battery cells include:
a positive terminal, a negative terminal, and a resistance terminal, and wherein the resistance terminal is connected to the internal cell resistance;
a switch circuit connected to the resistance terminal and one of the positive terminal or the negative terminal; and
wherein the control circuit is configured to activate the switch circuit to activate the internal cell resistance.

4. The system of claim 3, wherein the control circuit is configured to modulate activation of the switch circuit to reduce the charge level of the first battery cell.

5. The system of claim 3, including:
a heat transfer device; and
wherein the control circuit is configured to:
disconnect the internal cell resistance of the battery cells from the one of the positive terminal or the negative terminal; and
connect the internal cell resistance of the battery cells to the heat transfer device.

6. The system of claim 5, wherein the heat transfer device includes a cooling bus bar.

7. The system of claim 5, wherein the heat transfer device includes a peltier element.

8. The system of claim 1, wherein the multiple battery cells are connected in at least one battery cell string including at least a portion of the multiple battery cells connected in series.

9. A method of operating a battery cell system having multiple battery cells, the method comprising:
determining, by a control circuit of the battery cell system, that a charge level of a first battery cell is greater than the charge level of a second battery cell of the battery cell system;
activating an internal cell resistance of the first battery cell to reduce the charge level of the first battery cell; and
deactivating the internal cell resistance when the charge level of the first battery cell is within a specified threshold charge level of the second battery cell.

10. The method of claim 9, wherein the activating an internal cell resistance includes activating an internal cell resistance comprising multiple connected metal foils internal to the battery cell to internally dissipate charge of the first battery cell.

11. The method of claim 9, wherein the activating an internal cell resistance includes activating a switch to connect a resistance terminal of the battery cell to one of a positive terminal or a negative terminal of the battery cell, wherein the resistance terminal is connected to the internal cell resistance.

12. The method of claim 11, including modulating the activating of the internal cell resistance by activating and deactivating the switch to reduce the charge level of the first battery cell.

13. The method of claim 11, including:
deactivating the switch to disconnect the internal cell resistance from the one of the positive terminal or the negative terminal of the battery cell; and
connecting the internal cell resistance to a heat transfer device.

14. The method of claim 13, including:
connecting the internal cell resistance to a cooling bus bar.

15. The method of claim 13, including:
connecting the internal cell resistance to a Peltier element.

16. A battery cell system for a work machine, the system comprising:
multiple battery cells, wherein a battery cell includes multiple connected interleaved metal foils interleaved with battery cell plates of the battery cell; and
a heat transfer device dissipate heat from the interleaved metal foils.

17. The system of claim 16, wherein each of the multiple battery cells include a positive terminal, a negative terminal, and a third terminal, wherein the interleaved metal foils are connected to the third terminal.

18. The system of claim 17, including:
a switch circuit configured to connect the third terminal to the heat transfer device; and
a control circuit configured to:
determine a temperature of the battery cells; and
activate the switch circuit to connect the interleaved metal foils to the heat transfer device when the determined temperature of the battery cells being greater than a specified threshold temperature during a charging cycle of the battery system.

19. The system of claim 16, wherein the heat transfer device includes a cooling bus bar.

20. The system of claim 16, wherein the heat transfer device includes a Peltier element.
